(19) United States
(12) Patent Application Publication
(10) Pub. No.: US 2026/0095887 A1
(43) Pub. Date: Apr. 2, 2026

(54) POSITIONING OF COMMUNICATION DEVICE IN REGION

(71) Applicant: HUAWEI TECHNOLOGIES CO., LTD., Shenzhen (CN)

(72) Inventors: Majid Gerami, Lund (SE); Mohammad Javad Emadi, Lund (SE); Salah Eddine Hajri, Lund (SE); Thorsten Schier, Lund (SE)

(73) Assignee: HUAWEI TECHNOLOGIES CO., LTD., Shenzhen (CN)

(21) Appl. No.: 19/412,254

(22) Filed: Dec. 8, 2025

Related U.S. Application Data
(63) Continuation of application No. PCT/EP2023/065450, filed on Jun. 9, 2023.

(51) Int. Cl. H04W 64/00

(52) U.S. Cl. CPC H04W 64/00

(57) ABSTRACT

A first communication device transmits a positioning request in a region comprising a plurality of positioning supporting devices distributed in a plurality of sub-regions of the region. The first communication device receives a positioning response indicating an acknowledgement of the positioning request from a second communication device in the region. The positioning response may be received directly from the second communication device and/or via one or more of the plurality of positioning supporting devices. Based on the received positioning response, the first communication device determines a position of the second communication device in the region.

### CROSS-REFERENCE TO RELATED APPLICATIONS

This application is a continuation of International Application No. PCT/EP2023/065450, filed on June 9, 2023, the disclosure of which is hereby incorporated by reference in its entirety.

### TECHNICAL FIELD

Embodiments of the disclosure relate to a first communication device and a second communication device for positioning of the second communication device in a region. Furthermore, embodiments of the disclosure also relate to corresponding methods and a computer program.

### BACKGROUND

The study of positioning in cellular networks started back in around 1996, when federal communications commission (FCC) mandated operators to localize user equipment (UEs) for emergency call services. At the start, only cell identity was reported but the positioning methods evolved and became more accurate. Besides emergency call services, positioning of a UE has various applications in radio resource management, location-based services such as gaming, etc.

There are different schemes and techniques for obtaining a position of a UE. Some of the main positioning schemes are time of arrival (TOA), observed difference of time of arrival (ODTOA), angle of arrival (AoA), received signal strength (RSS) and fingerprinting. All with their respective advantages and disadvantages. TOA and ODTOA based positioning are sensitive to synchronization. AOA is also sensitive to scattering and multipath. Fingerprinting requires a large enough database of measurements and ground truth locations to be able to build a model with the targeted performance. It is also worth highlighting that, depending on the model complexity, a considerable computational and storage capacity may be needed for fingerprinting.

To obtain the position of a UE with the required and precise enough accuracy, the UE needs to measure positioning reference signal (PRS) or transmit sounding reference signal (SRS) over a large signaling bandwidth. The SRS transmissions, PRS measurement and computations for positioning have a large impact on power consumption and computational resources in the UE.

### SUMMARY

An objective of embodiments of the disclosure is to provide a solution which mitigates or solves the drawbacks and problems of conventional solutions.

Another objective of embodiments of the disclosure is to provide a solution for positioning which minimizes power consumption and processing in the UE, as well as reduces signaling and reporting overhead.

The above and further objectives are solved by the subject matter of the independent claims. Further embodiments of the disclosure can be found in the dependent claims.

According to a first aspect of the disclosure, the above mentioned and other objectives are achieved with a first communication device for a communication system, the first communication device being configured to:

transmit a positioning request in a region comprising a plurality of positioning supporting devices distributed in a plurality of sub-regions of the region;

receive a positioning response from a second communication device in the region, the positioning response indicating an acknowledgement of the positioning request; and

determine a position of the second communication device in the region based on the received positioning response from the second communication device.

The first communication device may transmit the positioning request and/or receive the positioning response with or without using beamforming. For example, the first communication device may cover the whole region and the first communication device may transmit the positioning request to the whole region. The first communication device may further transmit the positioning request in a direction of the second communication device and/or in directions of the plurality of positioning supporting devices using transmit beamforming. In a corresponding way, the first communication device may receive the positioning response from the second communication device without using receive beamforming or from the direction of the second communication device and/or from the directions of the plurality of positioning supporting devices using receive beamforming.

A region can herein be understood to be a two-dimensional region or a three-dimensional region, i.e., a two-dimensional area or a three-dimensional space.

An advantage of the first communication device according to the first aspect is that the second communication device can be positioned with a minimum of measurements and transmissions, thereby reducing processing and power consumption in the first and second communication devices. Furthermore, the signaling overhead for positioning can be reduced.

In an embodiment of a first communication device according to the first aspect, the first communication device is configured to:

receive a plurality of positioning responses from the plurality of positioning supporting devices, each positioning response indicating the acknowledgement of the positioning request; and

determine the position of the second communication device in the region further based on the plurality of positioning responses from the plurality of positioning supporting devices.

An advantage with this embodiment is that the first communication device can obtain the positing of the second communication device based on a simple acknowledgement, e.g., only one bit of information or one signature signal. This reduces the overhead in signaling. In addition, by transmitting a minimum number of bits, power consumption in the second communication device can be reduced and interference in the network can be reduced.

In an embodiment of a first communication device according to the first aspect, the acknowledgement of the positioning request comprises a bit, a signature or a positioning signal quality quantity.

An advantage with this embodiment is that the position of the second communication device can be obtained with a minimum of transmission power by the second communication device and also a minimum of processing and measurements in the first communication device.

In an embodiment of a first communication device according to the first aspect, the first communication device is configured to:

determine the position of the second communication device in the region further based on signal measurements of the plurality of position responses.

An advantage with this embodiment is that by analyzing the signal measurement of the plurality of position responses the first communication device can obtain the position of the second communication device more accurately. For example, by analyzing the power path losses from the received signals from different positioning responses, the position of the second communication device can be obtained more accurately compared to not analyzing the signal measurements of the plurality of position responses.

In an embodiment of a first communication device according to the first aspect, the first communication device is configured to:

determine the position of the second communication device in the region further based on the distribution of the plurality of positioning supporting devices in the plurality of sub-regions of the region.

An advantage with this embodiment is that by using the distribution of the plurality of positioning supporting devices in the plurality of sub-regions the first communication device can obtain the position of the second communication device more accurately.

In an embodiment of a first communication device according to the first aspect, the acknowledgement of the positioning request comprises an indication of received signal strengths of a plurality of positioning requests received by the second communication device from the plurality of positioning supporting devices. The indication may be in a bitmap format.

An advantage with this embodiment is that the acknowledgement of the positioning request comprises more bits of information and can convey the signal strength with which the second communication device received the plurality of positioning requests. The first communication device can thereby obtain the position of the second communication device more accurately.

In an embodiment of a first communication device according to the first aspect, the positioning response from the second communication device further indicates an estimate of the position of the second communication device.

An advantage with this embodiment is that the first communication device is provided with additional information for positioning and can obtain the positing of the second communication device with reduced processing.

In an embodiment of a first communication device according to the first aspect, the position of the second communication device and/or the estimate of the position of the second communication device is within a sub-region of the region.

An advantage with this embodiment is that by diving the region to smaller sub-regions a more accurate position of the second communication device can be obtained.

In an embodiment of a first communication device according to the first aspect, each sub-region is covered by at least one positioning supporting device.

An advantage with this embodiment is that the position of the second communication device can be obtained with the resolution of one sub-region with minimum transmission, e.g., one bit acknowledgement, from each of positioning supporting device, i.e., from each sub-region.

In an embodiment of a first communication device according to the first aspect, the first communication device is configured to:

transmit a plurality of control signals to the plurality of positioning supporting devices, each control signal indicating a receive direction and/or a transmit direction for a positioning supporting device to cover a sub-region of the region.

An advantage with this embodiment is that the first communication device can control the plurality of positioning supporting devices to forward the positioning request from the first communication device to the sub-regions and/or the positioning response from the sub-regions to the first communication device.

In an embodiment of a first communication device according to the first aspect, the receive direction and/or the transmit direction of the positioning supporting device comprises one or more of a transmit beam, a receive beam, a mechanical tilt, an antenna direction, a beam width, and a beam direction.

An advantage with this embodiment is that parameters determining the forwarding direction of the plurality of positioning supporting devices can be controlled by the first communication device.

In an embodiment of a first communication device according to the first aspect, the control signal further indicates a transmit power and/or a time/frequency resource for the positioning response.

An advantage with this embodiment is that the first communication device can control power and/or resources for the positioning response to avoid interference with other transmissions. Furthermore, by controlling the time/frequency resource for the positioning response, the first communication device knows when and where to listen for the positioning response.

In an embodiment of a first communication device according to the first aspect, the positioning request indicates a reference signal to measure and report, a time/frequency reporting resource for the positioning response and/or a number of reporting bits for the positioning response.

An advantage with this embodiment is that the first communication device can trigger the second communication device to perform reference signal measurements to improve the accuracy of the positioning. In addition, the first communication device can indicate to the second communication device when to transmit the positioning response and on which frequencies, as well as which resolution/accuracy to use for the positioning response. The positioning accuracy can thereby be adapted based on use case and interference in the network can be avoided.

In an embodiment of a first communication device according to the first aspect, the positioning response further indicates a received signal strength of the reference signal.

An advantage with this embodiment is that the first communication device is provided with additional information for positioning and can obtain the positing of the second communication device with improved accuracy.

In an embodiment of a first communication device according to the first aspect, the positioning request is a downlink control information (DCI), a sidelink control information (SCI) or a positioning protocol message; and/or the positioning response is an uplink control information (UCI), an SCI or a positioning protocol message.

An advantage with this embodiment is that existing control signals can be used and can be re-purposed for the task of positing, thereby facilitating the embodiment.

In an embodiment of a first communication device according to the first aspect, the positioning supporting device is an intelligent reflecting surface, a transmission and reception point, a relay/repeater node, a network access node, or a client device.

An advantage with this embodiment is that existing network nodes and a plurality of different types of network nodes can be used for the task of supporting the first communication device in positioning of the second communication device. A flexible positioning solution is thereby provided.

According to a second aspect of the disclosure, the above mentioned and other objectives are achieved with a second communication device for a communication system, the second communication device being configured to:

receive a positioning request from a first communication device; and

transmit a positioning response to the first communication device in response to reception of the positioning request, the positioning response indicating an acknowledgement of the positioning request.

An advantage of the second communication device according to the second aspect is that the second communication device can be positioned with a minimum of measurements and transmissions, thereby reducing processing and power consumption in the first and second communication devices. Furthermore, the signaling overhead for positioning can be reduced.

In an embodiment of a second communication device according to the second aspect, the acknowledgement of the positioning request comprises a bit, a signature or a positioning signal quality quantity.

An advantage with this embodiment is that the position of the second communication device can be obtained with a minimum of transmission power by the second communication device and also a minimum of processing and measurements in the first communication device.

In an embodiment of a second communication device according to the second aspect, the second communication device is configured to:

receive a plurality of positioning requests from a plurality of positioning supporting devices distributed in a plurality of sub-regions of a region; and

wherein the acknowledgement of the positioning request comprises an indication of received signal strengths of the plurality of received positioning requests.

An advantage with this embodiment is that the acknowledgement of the positioning request comprises more bits of information and can convey the signal strength with which the second communication device received the plurality of positioning requests. The position of the second communication device can thereby be obtained more accurately.

In an embodiment of a second communication device according to the second aspect, the second communication device is configured to:

estimate a position of the second communication device in the region based on the plurality of position requests received from the plurality of positioning supporting devices; and wherein the positioning response further indicates the estimate of the position of the second communication device in the region.

An advantage with this embodiment is that the second communication device can provide additional information for positioning to the first communication device, allowing the position of the second communication device to be obtained more accurately and with reduced processing in the first communication device.

In an embodiment of a second communication device according to the second aspect, the estimated position of the second communication device is within a sub-region of the region.

An advantage with this embodiment is that by diving the region to smaller sub-regions a more accurate position of the second communication device can be obtained.

In an embodiment of a second communication device according to the second aspect, the positioning request indicates one or more of a reference signal to measure and report, a time/frequency reporting resource for the positioning response and a number of reporting bits for the positioning response.

An advantage with this embodiment is that the second communication device can be triggered to perform reference signal measurements to improve the accuracy of the positioning. In addition, the second communication device can be informed about when to transmit the positioning response and on which frequencies, as well as which resolution/accuracy to use for the positioning response. The positioning accuracy can thereby be adapted based on use case and interference in the network can be avoided.

In an embodiment of a second communication device according to the second aspect, the positioning response further indicates a received signal strength of the reference signal.

An advantage with this embodiment is that the second communication device provides additional information for positioning to the first communication device. The accuracy of the positioning can thereby be improved. Furthermore, as no analysis of the received signal to obtain position is performed in the second communication device, the power consumption and processing in the second communication device is reduced.

In an embodiment of a second communication device according to the second aspect, the positioning request is a downlink control information (DCI), a sidelink control information (SCI) or a positioning protocol message; and/or the positioning response is an uplink control information (UCI), an SCI or a positioning protocol message.

An advantage with this embodiment is that existing control signals can be used and can be re-purposed for the task of positing, thereby facilitating the embodiment.

According to a third aspect of the disclosure, the above mentioned and other objectives are achieved with a method for a first communication device, the method comprises:

transmitting a positioning request in a region comprising a plurality of positioning supporting devices distributed in a plurality of sub-regions of the region;

receiving a positioning response from a second communication device in the region, the positioning response indicating an acknowledgement of the positioning request; and

determining a position of the second communication device in the region based on the received positioning response from the second communication device.

The method according to the third aspect can be extended into embodiments corresponding to the embodiments of the first communication device according to the first aspect. Hence, an embodiment of the method comprises the feature(s) of the corresponding embodiment of the first communication device.

The advantages of the methods according to the third aspect are the same as those for the corresponding embodiments of the first communication device according to the first aspect.

According to a fourth aspect of the disclosure, the above mentioned and other objectives are achieved with a method for a second communication device, the method comprises:

receiving a positioning request from a first communication device; and

transmitting a positioning response to the first communication device in response to reception of the positioning request, the positioning response indicating an acknowledgement of the positioning request.

The method according to the fourth aspect can be extended into embodiments corresponding to the embodiments of the second communication device according to the second aspect. Hence, an embodiment of the method comprises the feature(s) of the corresponding embodiment of the second communication device.

The advantages of the methods according to the fourth aspect are the same as those for the corresponding embodiments of the second communication device according to the second aspect.

Embodiments of the disclosure also relate to a computer program, characterized in program code, which when run by at least one processor causes the at least one processor to execute any method according to embodiments of the disclosure. Further, embodiments of the disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the disclosure will be apparent from the following detailed description.

### BRIEF DESCRIPTION OF THE DRAWINGS

The appended drawings are intended to clarify and explain different embodiments of the disclosure, in which:

FIG. 1 shows a first communication device according to an embodiment of the disclosure;

FIG. 2 shows a flow chart of a method for a first communication device according to an embodiment of the disclosure;

FIG. 3 shows a second communication device according to an embodiment of the disclosure;

FIG. 4 shows a flow chart of a method for a second communication device according to an embodiment of the disclosure;

FIG. 5 shows a communication system according to an embodiment of the disclosure; and

FIG. 6 shows signaling for positioning of a second communication device according to an embodiment of the disclosure;

FIG. 7 shows signaling for positioning of a second communication device based on a plurality of positioning responses according to an embodiment of the disclosure;

FIG. 8 shows signaling for positioning of a second communication device based on a plurality of positioning requests according to an embodiment of the disclosure; and

FIG. 9 shows a communication system according to an embodiment of the disclosure.

### DETAILED DESCRIPTION

Finding the position of UEs, including devices such as internet of things (IoT) devices, sensors, etc., is important in many use-cases, e.g., industry and warehouse management, vehicle to everything (V2X), autonomous driving, extended reality (XR), and gaming. The existing positioning schemes consume considerable battery power in the UE.

According to embodiments of the disclosure a positioning solution is therefore provided which consumes a minimum of battery power and UE processing, as well as minimize overhead of required signaling and reporting. As the proposed positioning solution reduces the processing cost at the UE, it is suitable for extremely reduced capable (X-RedCap) devices. Embodiments of the disclosure can further improve energy efficiency by omitting positioning quantities computation and reducing positioning-relevant reporting overhead.

Another benefit of the proposed solution is that it adds flexibility to the network to decide, depending on the use-case, the required level of accuracy in positioning. In this way, subsequent resource utilization may be adapted based on required level of accuracy.

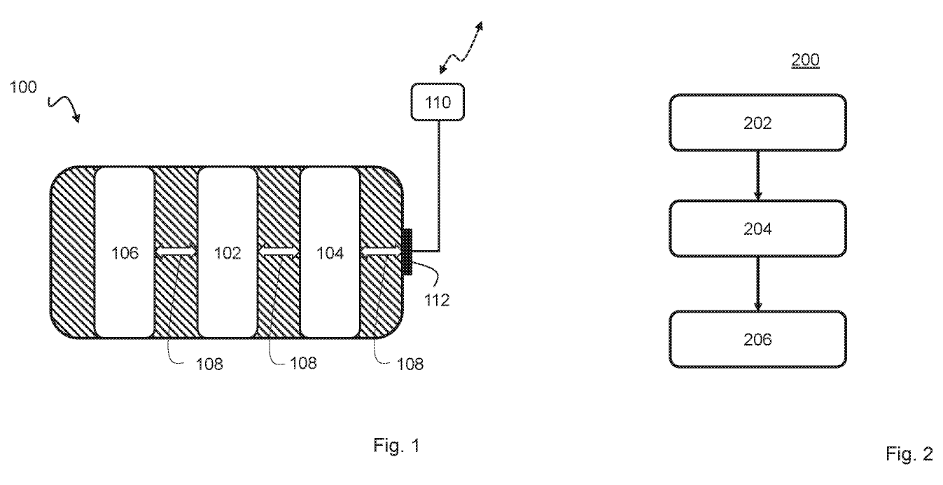

FIG. 1 shows a first communication device 100 according to an embodiment of the disclosure. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the disclosure the first communication device 100 is configured to transmit a positioning request 620 in a region R comprising a plurality of positioning supporting devices 500a, 500b, … 500n distributed in a plurality of sub-regions R1, R2, …, Rn of the region R. The first communication device 100 is further configured to receive a positioning response 630 from a second communication device 300 in the region R, the positioning response 630 indicating an acknowledgement of the positioning request 620. The first communication device 100 is further configured to determine a position P of the second communication device 300 in the region R based on the received positioning response 630 from the second communication device 300.

Furthermore, in an embodiment of the disclosure, the first communication device 100 for a communication system 500 comprises: a transceiver configured to: transmit a positioning request 620 in a region R comprising a plurality of positioning supporting devices 500a, 500b, … 500n distributed in a plurality of sub-regions R1, R2, …, Rn of the region R; and receive a positioning response 630 from a second communication device 300 in the region R, the positioning response 630 indicating an acknowledgement of the positioning request 620; and a processor configured to: determine a position P of the second communication device 300 in the region R based on the received positioning response 630 from the second communication device 300.

Moreover, in yet another embodiment of the disclosure, the first communication 100 for a communication system 500 comprises a processor and a memory having computer readable instructions stored thereon which, when executed by the processor, cause the processor to: transmit a positioning request 620 in a region R comprising a plurality of positioning supporting devices 500a, 500b, … 500n distributed in a plurality of sub-regions R1, R2, …, Rn of the region R; receive a positioning response 630 from a second communication device 300 in the region R, the positioning response 630 indicating an acknowledgement of the positioning request 620; and determine a position P of the second communication device 300 in the region R based on the received positioning response 630 from the second communication device 300.

FIG. 2 shows a flow chart of a corresponding method 200 which may be executed in a first communication device 100, such as the one shown in FIG. 1. The method 200 comprises transmitting 202 a positioning request 620 in a region R comprising a plurality of positioning supporting devices 500a, 500b, … 500n distributed in a plurality of sub-regions R1, R2, …, Rn of the region R. The method 200 further comprises receiving 204 a positioning response 630 from a second communication device 300 in the region R, the positioning response 630 indicating an acknowledgement of the positioning request 620. Furthermore, the method 200 comprises determining 206 a position P of the second communication device 300 in the region R based on the received positioning response 630 from the second communication device 300.

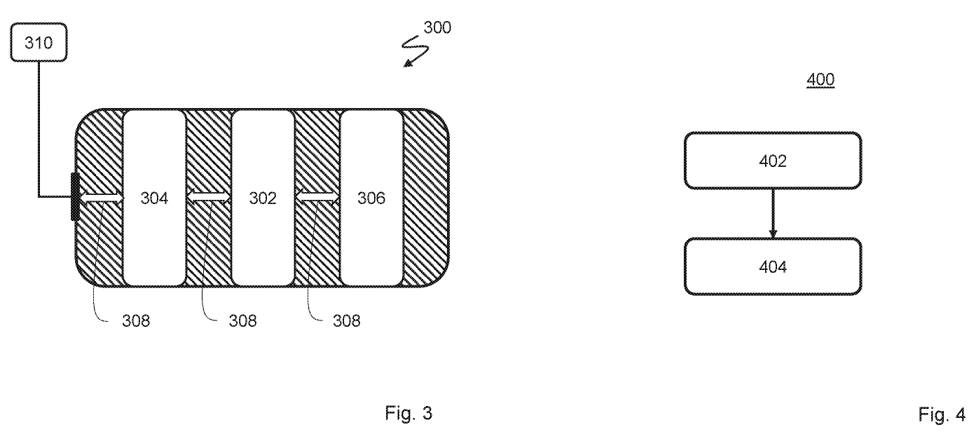

FIG. 3 shows a second communication device 300 according to an embodiment of the disclosure. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the disclosure the second communication device 300 is configured to receive a positioning request 620 from a first communication device 100. The second communication device 300 is further configured to transmit a positioning response 630 to the first communication device 100 in response to reception of the positioning request 620, the positioning response 630 indicating an acknowledgement of the positioning request 620.

Furthermore, in an embodiment of the disclosure, the second communication device 300 for a communication system 500 comprises: a transceiver configured to: receive a positioning request 620 from a first communication device 100 and transmit a positioning response 630 to the first communication device 100 in response to reception of the positioning request 620, the positioning response 630 indicating an acknowledgement of the positioning request 620.

Moreover, in yet another embodiment of the disclosure, the second communication device 300 for a communication system 500 comprises a processor and a memory having computer readable instructions stored thereon which, when executed by the processor, cause the processor to: receive a positioning request 620 from a first communication device 100 and transmit a positioning response 630 to the first communication device 100 in response to reception of the positioning request 620, the positioning response 630 indicating an acknowledgement of the positioning request 620.

FIG. 4 shows a flow chart of a corresponding method 400 which may be executed in a second communication device 300, such as the one shown in FIG. 3. The method 400 comprises receiving 402 a positioning request 620 from a first communication device 100. The method 400 further comprises transmitting 404 a positioning response 630 to the first communication device 100 in response to reception of the positioning request 620, the positioning response 630 indicating an acknowledgement of the positioning request 620.

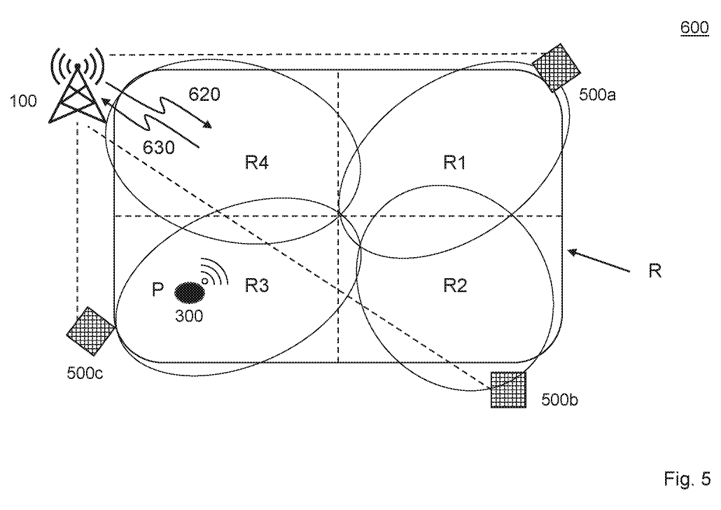

FIG. 5 shows a communication system 560 according to an embodiment of the disclosure. The communication system 600 in the disclosed embodiment comprises a first communication device 100 and a second communication device 300 configured to communicate and operate in the communication system 600. In the shown embodiment, the first communication device 100 is a network access node such as a base station, a next generation nodeB, etc. However, in some embodiments, the first communication device 100 may instead be a network node such as a location management function (LMF). The second communication device 300 is a mobile device such as a client device, an IoT device, a sensor, etc.

The communication system 600 in the disclosed embodiment further comprises a plurality of positioning supporting devices 500a, 500b, 500c distributed in a plurality of sub-regions R1, R2, R3 of a region R. The region R and the sub-regions R1, R2, R3, R4 may be two dimensional or three dimensional. The plurality of positioning supporting devices 500a, 500b, 500c may have a wireless connection to the first communication device 100, as indicated with dashed lines in FIG. 5, and may be controlled by the first communication device 100 to cover a respective sub-region R1, R2, R3 and to support in positioning of the second communication device 300. One of the sub-regions R4 are illustrated to be covered by the first communication device 100 but all the sub-region R1, R2, R3, R4 of the region R may in some embodiments instead be covered by a respective positioning supporting device 500.

In the embodiment shown in FIG. 5, the plurality of positioning supporting devices 500a, 500b, 500c are intelligent reflecting surfaces. The intelligent reflecting surfaces comprise metamaterial that can be controlled to reflect a received signal in an intended direction, i.e., reflect an incident wave from a source towards a destination. Intelligent reflecting surfaces can thereby improve the performance of the communications between the source and the destination. However, each positioning supporting device 500 may be any one of an intelligent reflecting surface, a transmission and reception point, a relay/repeater node, a network access node, or a client device and the plurality of positioning supporting devices 500a, 500b, …, 500n may comprise any combination thereof.

The first communication device 100 and/or the plurality of positioning supporting devices 500a, 500b, …, 500n may be equipped with multiple/massive antenna elements which may be directed to cover a respective sub-region Rn of the region R, as shown in FIG. 5.

According to embodiments of the disclosure the first communication device 100 is enabled to determine a position P of the second communication device 300 in the region R. The first communication device 100 transmits a positioning request 620 in the region R and receives a positioning response 630 indicating an acknowledgement of the positioning request 620 from the second communication device 300. The positioning request 620 or the positioning response 630 may be reflected or forwarded by the plurality of positioning supporting devices 500a, 500b, …, 500n to or from their respective sub-regions Rn. The second communication device 300 may hence receive one or more instances of the positioning request 620 from one or more of the first communication device 100 and the plurality of positioning supporting devices 500a, 500b, …, 500n; or the first communication device 100 may receive one or more instances of the positioning response 630 from one or more of the second communication device 300 and the plurality of positioning supporting devices 500a, 500b, …, 500n. Based on the positioning response 630 from the second communication device 300, the first communication device 100 determines a position P of the second communication device 300 in the region R. The position P of the second communication device 300 may be within a sub-region Rn of the region R.

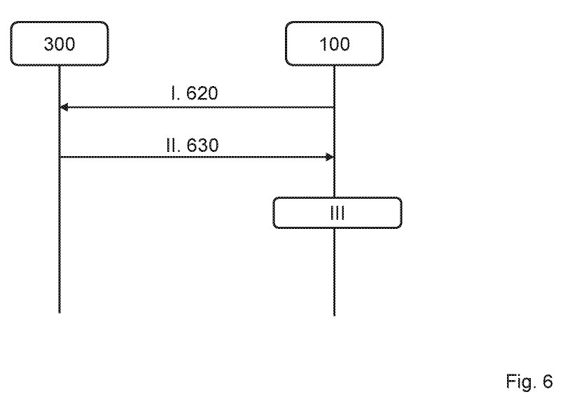

FIG. 6 shows signaling for positioning of the second communication device 300 according to an embodiment of the disclosure. The positioning may be initiated by the first communication device 100 to locate the second communication device 300 within a region R. The region R comprises a plurality of positioning supporting devices 500a, 500b, … 500n distributed in a plurality of sub-regions R1, R2, …, Rn of the region R, as described with reference to FIG. 5. Each positioning supporting device 500n may cover a respective sub-region Rn of the region R, i.e., reflect or forward signals to and/or from the sub-region Rn. The first communication device 100 may or may not cover one of the sub-regions R1, R2, …, Rn. In some embodiments, the first communication device 100 may be comprised in the plurality of positioning supporting devices 500a, 500b, … 500n.

In operation I in FIG. 6, the first communication device 100 transmits a positioning request 620 in the region R. The first communication device 100 may transmit the positioning request 620 in the whole region R, e.g., by broadcasting the positioning request 620 in its coverage area. The first communication device 100 may further transmit the positioning request 620 in an estimated direction of the second communication device 300 and/or directions of the plurality of positioning supporting devices 500a, 500b, … 500n using transmit beamforming. The transmit and receive beamforming weights can be derived during initial access, channel state information reporting or any of beam management procedures. The positioning request 620 may be a downlink control information (DCI), a sidelink control information (SCI) or a positioning protocol message.

The positioning request 620 may indicate a request to respond to the positioning request 620 with a positioning response 630 indicating an acknowledgement of the positioning request 620. In some embodiments, the positioning request 620 further indicates one or more of a reference signal to measure and report, a time/frequency reporting resource for the positioning response 630 and a number of reporting bits for the positioning response 630.

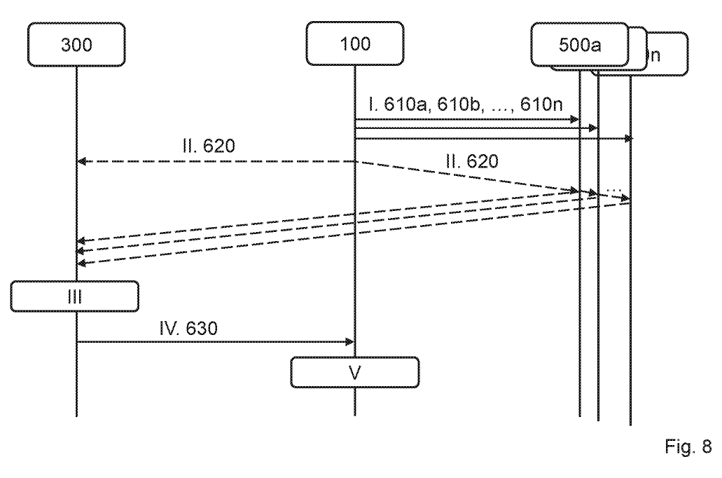

The second communication device 300 receives the positioning request 620 from the first communication device 100. The second communication device 300 may receive the positioning request 620 directly from the first communication device 100 and/or via the plurality of positioning supporting devices 500a, 500b, … 500n, as further described below with reference to FIG. 8. In other words, the second communication device 300 may receive one or more instances of the positioning request 620.

In operation II in FIG. 6, the second communication device 300 transmits a positioning response 630 to the first communication device 100 in response to reception of the positioning request 620. The second communication device 300 may transmit the positioning response 630 in its coverage area, e.g., by broadcasting the positioning response 630. The second communication device 300 may further transmit the positioning response 630 using transmit beamforming in a direction of the first communication device 100 and/or directions of the plurality of positioning supporting devices 500a, 500b, … 500n. The beamforming capabilities of the second communication device 300 may be used to select the right option for transmission and reception beamforming. The positioning response 630 indicates an acknowledgement of the positioning request 620. The acknowledgement of the positioning request 620 may be a simple indication that the positioning request 620 was received or an indication of all received instances of the positioning request 620, e.g., from which devices the positioning request 620 was received. The positioning response 630 may be an uplink control information (UCI), a SCI or a positioning protocol message.

When the positioning request 620 indicates a reference signal to measure and report, the positioning response 630 may further indicate a received signal strength of the reference signal. The second communication device 300 may hence perform signal measurements and report the received signal strength of the reference signal to the first communication device 100 in the positioning response 630. The reference signal to be measure may be transmitted by the first communication device 100 periodically and/or may be triggered by the positioning request 620. The reference signal may e.g., be a positioning reference signal or a channel state information reference signal but is not limited thereto.

Both the content and the actual transmission of the positioning response 630 may be based on the positioning request 620. For example, the second communication device 300 may transmit the positioning response 630 in a time/frequency reporting resource for the positioning response 630 indicated in the positioning request 620 and/or adapt a reporting type based on a number of reporting bits for the positioning response 630 indicated in the positioning request 620.

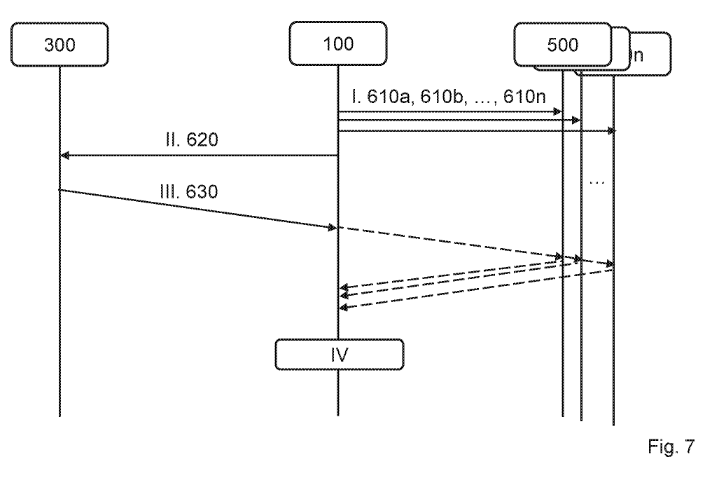

The first communication device 100 receives the positioning response 630 indicating the acknowledgement of the positioning request 620 from the second communication device 300. The first communication device 100 may receive the positioning response 630 from the direction of the second communication device 300 and/or from directions of the plurality of positioning supporting devices 500a, 500b, … 500n using receive beamforming. The positioning response 630 may hence be received directly from the second communication device 300 and/or via the plurality of positioning supporting devices 500a, 500b, … 500n, as further described below with reference to FIG. 7. In other words, the first communication device 100 may receive one or more instances of the positioning response 630.

In operation III in FIG. 6, the first communication device 100 determines a position P of the second communication device 300 in the region R based on the received positioning response 630 from the second communication device 300, e.g., based on the acknowledgement of the positioning request 620 indicated in the positioning response 630. The position P of the second communication device 300 may be within a sub-region Rn of the region R, i.e., the first communication device 100 may determine in which sub-region Rn the second communication device 300 is positioned.

FIG. 7 shows signaling for positioning of the second communication device 300 according to embodiments of the disclosure where the positioning response 630 from the second communication device 300 is reflected or forwarded by the plurality of positioning supporting devices 500a, 500b, … 500n to the first communication device 100. In the shown embodiment, the first communication device 100 controls the plurality of positioning supporting devices 500a, 500b, … 500n to support in the positioning of the second communication device 300 using a plurality of control signals 610a, 610b, …, 610n. However, the plurality of positioning supporting devices 500a, 500b, … 500n may in some embodiments instead be controlled or configured to cover a respective sub-region Rn of the region R in other ways, e.g., be pre-configured or controlled by another node or device.

In operation I in FIG. 7, the first communication device 100 transmits a plurality of control signals 610a, 610b, …, 610n to the plurality of positioning supporting devices 500a, 500b, … 500n. Each control signal 610n indicates a receive direction and/or a transmit direction for a positioning supporting device 500n to cover a sub-region Rn of the region R. With the plurality of control signals 610a, 610b, …, 610n, the first communication device 100 may hence control the receive directions and/or the transmit directions of the plurality of positioning supporting devices 500a, 500b, … 500n. The receive directions and/or the transmit directions may be controlled such that the plurality of positioning supporting devices 500a, 500b, … 500n reflects or forwards a positioning response 630 from the second communication device 300 in their respective sub-region Rn to the first communication device 100.

In some embodiments, each sub-region Rn is covered by at least one positioning supporting device 500n. Independently of in which sub-region Rn the second communication device 300 is currently positioned, the positioning response 630 from the second communication device 300 may hence be forwarded by at least one positioning supporting device 500 to the first communication device 100.

The receive direction and/or the transmit direction of the positioning supporting device 500 indicated in the control signal 610 may comprise one or more of a transmit beam, a receive beam, a mechanical tilt, an antenna direction, a beam width, and a beam direction. In other words, the control signal 610 may adapt parameters for beamforming and/or antenna position.

In some embodiments, the control signal 610 further indicates a transmit power and/or a time/frequency resource for the positioning response 630. In this way, the amplitude of the reflected or forwarded signal may be adapted and/or the positioning supporting device 500 may be activated to reflect or forward the positioning response 630 received in the indicated time/frequency resource.

The first communication device 100 may directly or indirectly control the receive directions and/or the transmit directions of the plurality of positioning supporting devices 500a, 500b, … 500n. The control signal 610 may e.g., directly adapt/adjust the receive direction and/or the transmit direction of the positioning supporting device 500 by controlling a tilt motor and/or an electronic unit of the positioning supporting device 500. For example, the tilt motor may be controlled to change a tilt and/or angle of an antenna array/elements of the positioning supporting device 500 and/or the electronic unit may be controlled to change phase of antenna elements of the positioning supporting device 500. The control signal 610 may further indicate a configuration which is received and implemented by the positioning supporting device 500.

In operation II in FIG. 7, the first communication device 100 transmits a positioning request 620 in the region R. The first communication device 100 may broadcast the positioning request 620 in the region R or transmit the positioning request 620 in the region R using transmit beamforming. In other words, the positioning request 620 may be transmitted to the whole region R with or without using beamforming.

In operation III in FIG. 7, the second communication device 300 responds to the positioning request 620 by transmitting a positioning response 630 indicating an acknowledgement of the positioning request 620. The positioning response 630 may be transmitted in the region R with or without using beamforming. The acknowledgement of the positioning request 620 may comprise a bit, a signature or a positioning signal quality quantity. For example, a single bit may be used as acknowledgement. Thus, a minimum of signaling resources are needed for the transmission of the positioning response 630.

With reference to FIG. 7, the positioning response 630 may be reflected or forwarded by one or more positioning supporting devices in the plurality of positioning supporting devices 500a, 500b, … 500n depending on which sub-region Rn the second communication device 300 is positioned in. Thus, the first communication device 100 receives the positioning response 630 from the second communication device 300 and/or a plurality of positioning responses 630a, 630b, … 630n from the plurality of positioning supporting devices 500a, 500b, … 500n. Each positioning response 630n indicates the acknowledgement of the positioning request 620.

In operation IV in FIG. 7, the first communication device 100 determines the position P of the second communication device 300 in the region R based on the positioning response 630 from the second communication device 300 and/or the plurality of positioning responses 630a, 630b, … 630n from the plurality of positioning supporting devices 500a, 500b, … 500n. For example, the first communication device 100 may determine from which devices 300, 500a, 500b, … 500n the positioning response 630 was received and thereby determine in which sub-region Rn the second communication device 300 is positioned.

In some embodiments, the first communication device 100 may determine the position P of the second communication device 300 in the region R further based on signal measurements of the plurality of position responses 630a, 630b, … 630n. The signal measurements may be a received signal strength. Based on the received signal strength for the plurality of position responses 630a, 630b, … 630n, the first communication device 100 may estimate the distance between the second communication device 300 and each positioning supporting device 500. For example, the first communication device 100 may estimate the pathloss between the second communication device 300 and the positioning supporting device 500 from the forwarded position response 630, and then, using prior knowledge of the distance between the positioning supporting device 500 and the first communication device 100, the position P of the second communication device 300 may be determined.

In some embodiments, the first communication device 100 may determine the position P of the second communication device 300 in the region R further based on the distribution of the plurality of positioning supporting devices 500a, 500b, … 500n in the plurality of sub-regions R1, R2, …, Rn of the region R. The distribution of the plurality of positioning supporting devices 500a, 500b, … 500n may e.g., be absolute or relative positions of the positioning supporting devices 500a, 500b, … 500n in the region R. The distribution of the plurality of positioning supporting devices 500a, 500b, … 500n may be used to determines the position P of the second communication device 300 within a sub-region Rn by determining from which of the positioning supporting devices 500a, 500b, … 500n a positioning response 630 was received. The distribution of the plurality of positioning supporting devices 500a, 500b, … 500n may further be used together with signal measurements to more accurately determine the position P of the second communication device 300, as described above.

FIG. 8 shows signaling for positioning of the second communication device 300 according to an embodiment of the disclosure where the positioning request 620 from the first communication device 100 is reflected or forwarded by the plurality of positioning supporting devices 500a, 500b, … 500n to the sub-regions R1, R2, …, Rn of the region R. In the shown embodiment, the first communication device 100 controls the plurality of positioning supporting devices 500a, 500b, … 500n to support in the positioning of the second communication device 300 using a plurality of control signals 610a, 610b, …, 610n. However, the plurality of positioning supporting devices 500a, 500b, … 500n may in some embodiments instead be controlled or configured to cover a respective sub-region Rn of the region R in other ways, e.g., be pre-configured or controlled by another node or device.

In operation I in FIG. 8, the first communication device 100 transmits a plurality of control signals 610a, 610b, …, 610n to the plurality of positioning supporting devices 500a, 500b, … 500n. Each control signal 610n indicates a receive direction and/or a transmit direction for a positioning supporting device 500n to cover a sub-region Rn of the region R. With the plurality of control signals 610a, 610b, …, 610n, the first communication device 100 may hence control the plurality of positioning supporting devices 500a, 500b, … 500n to receive the positioning request 620 from the first communication device 100 and to reflect or forward the positioning request 620 to their respective sub-regions Rn.

In some embodiments, each sub-region Rn is covered by at least one positioning supporting device 500n. Independently of in which sub-region Rn the second communication device 300 is currently positioned, the positioning request 620 from the first communication device 300 is forwarded by at least one positioning supporting device 500 to the second communication device 300.

As previously described, the receive direction and/or the transmit direction of the positioning supporting device 500 indicated in the control signal 510 may comprise one or more of a transmit beam, a receive beam, a mechanical tilt, an antenna direction, a beam width, and a beam direction. In addition, the control signal 610 may further indicate a transmit power and/or a time/frequency resource for the positioning response 630.

In operation II in FIG. 8, the first communication device 100 transmits a positioning request 620 to the second communication device 300 in the region R. The first communication device 100 may broadcast the positioning request 620 in the region R or transmit the positioning request 620 using transmit beamforming in an estimated direction of the second communication device 300 and/or directions the plurality of positioning supporting devices 500a, 500b, … 500n.

With reference to FIG. 8, the plurality of positioning supporting devices 500a, 500b, … 500n receives the positioning request 620 from the first communication device 100 and based on the plurality of control signals 610a, 610b, …, 610n the plurality of positioning supporting devices 500a, 500b, … 500n forward or reflect the positioning request 620 to their respective sub-regions R1, R2, …, Rn. Thus, the second communication device 300 may receive the positioning request 620 from the first communication device 100 and/or receive a plurality of positioning requests 620a, 620b, … 620n from the plurality of positioning supporting devices 500a, 500b, … 500n.

In operation III in FIG. 8, the second communication device 300 processes the received positioning requests 620a, 620b, … 620n to determine a positioning response 630 indicating an acknowledgement of the positioning request 620. To determine the acknowledgement of the positioning request 620, the second communication device 300 may further perform signal measurements on the plurality of positioning requests 620a, 620b, … 620n. The acknowledgement of the positioning request 620 may indicate from which positioning supporting devices 500a, 500b, … 500n the plurality of positioning requests 620a, 620b, … 620n were received and/or received signal strengths of the received positioning requests 620a, 620b, … 620n.

Thus, the acknowledgement of the positioning request 620 may comprise an indication of received signal strengths of the plurality of received positioning requests 620a, 620b, … 620n. The indication may be in a bit map format. In some embodiments, one bit per positioning supporting device 500 may be used to indicate whether the received signal strength of the positioning request 620 received from the positioning supporting device 500 was above a threshold value or not. For example, a “1” may be used to indicate a positive acknowledgement, i.e., that the received signal strength of the positioning request 620 is above the threshold value. For a region R with N sub- regions, the number of bits for the acknowledgement of the positioning request 620 in the positioning response 630 may be log₂(N).

In some embodiments, the second communication device 300 may in operation III in FIG. 8 further estimate a position P´ of the second communication device 300 in the region R based on the plurality of position requests 620a, 620b, … 620n received from the plurality of positioning supporting devices 500a, 500b, … 500n. The estimated position P´ of the second communication device 300 may be within a sub-region Rn of the region R. The second communication device 300 may e.g., determine the position request 620 from among the plurality of position requests 620a, 620b, … 620n received with the highest signal strength and determine the estimated position P´ to be the sub-region Rn associated with the position request 620.

The second communication device 300 may report the estimated position P´ to the first communication device 100 in the positioning response 630. The positioning response 630 may hence further indicate the estimate of the position P´ of the second communication device 300 in the region R, e.g., indicate a sub-region Rn.

When the positioning request 620 indicates a reference signal to measure and report, the second communication device 300 may further measure the reference signal in operation III in FIG. 8 and report the measured received signal strength of the reference signal in the positioning response 630. Thus, the positioning response 630 may further indicates a received signal strength of the reference signal.

In operation IV in FIG. 8, the second communication device 300 transmits the positioning response 630 to the first communication device 100 in response to the positioning request 620 from the first communication device 100. The positioning response 630 indicates the acknowledgement of the positioning request 620 and/or the estimated position P´ of the second communication device 300 determined in operation III in FIG. 8.

The first communication device 100 receives the positioning response 630 from the second communication device 300 and hence obtains the acknowledgement of the positioning request 620 indicated in the positioning response 630.

In operation V in FIG. 8, the first communication device 100 determines a position P of the second communication device 300 in the region R based on the received positioning response 630, e.g., based on the acknowledgement of the positioning request 620 indicated in the positioning response 630. When the acknowledgement of the positioning request 620 comprises an indication of received signal strengths of the plurality of positioning requests 620a, 620b, … 620n received by the second communication device 300, the first communication device 100 may determine the position P of the second communication device 300 based on the indication of received signal strengths. For example, based on which positioning requests 620a, 620b, … 620n are indicated to have been received with high signal strength by the second communication device 300. The first communication device 100 may further consider a received signal strength of a reference signal indicated in the positioning response 630.

When the positioning response 630 from the second communication device 300 further indicates an estimate of the position P´ of the second communication device 300, the first communication device 100 may determine the position P of the second communication device 300 based on the estimated position P´. The position P of the second communication device 300 and/or the estimate of the position P´ of the second communication device 300 may be within a sub-region Rn of the region R.

To further improve the accuracy of the positioning, the positioning process according to any of the herein described embodiments may be iterative, i.e., the positioning process may be repeated until the required accuracy is satisfied. In each iteration, a new region R´ may be divided into a plurality of new sub-regions R1´, R2´, …, Rn´, where the new region R´ may correspond to the sub-region Rn within which the second communication device 300 is determined to be positioned in the previous iteration. The plurality of new sub-regions R1´, R2´, …, Rn´ may be covered by the same or a different set of positioning supporting devices 500a, 500b, … 500n compared to the previous iteration. In other words, for each iteration the region R may be divided into a plurality of sub-regions R1, R2, …, Rn and a plurality of positioning supporting devices 500a, 500b, … 500n may be controlled to cover the plurality of sub-regions R1, R2, …, Rn.

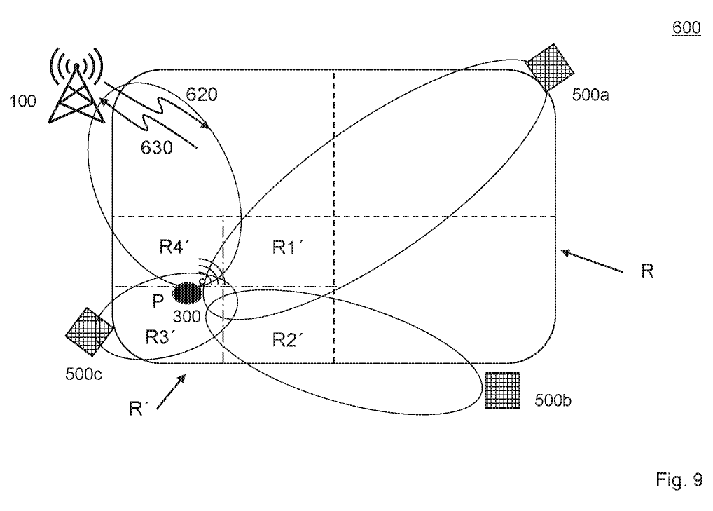

With reference to FIG. 5, assume that in a first iteration the second communication device 300 has been determined to be positioned in a third sub-region R3. With reference to FIGS. 9, in the next iteration, the third sub-region R3 is the new region R´ and it is divided into a plurality of new sub-regions R1´, R2´, R3´, R4´. The first communication device 100 and the plurality of positioning supporting devices 500a, 500b, 500c are controlled to cover a respective new sub-regions Rn´, as shown in FIG. 9. In the shown embodiment, the same set of positioning supporting devices 500a, 500b, 500c are used for both iterations. However, a different set of positioning supporting devices 500a, 500b, …, 500n may in some embodiments be used for each iteration.

A first communication device herein may also be denoted as a network node, a network access node or a client device and a second communication device herein may be denoted as a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the disclosure may be implemented in a computer program, having code means, which when run by processing means causes the processing means to execute the operations of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the communication capabilities in the form of e.g., functions, means, units, elements, etc., for performing or implementing embodiments of the disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the disclosure is not limited to the embodiments described above, but also relates to and incorporates all embodiments within the scope of the appended independent claims.

1. A first communication device for a communication system, the first communication device being configured to:
transmit a positioning request in a region comprising a plurality of positioning supporting devices distributed in a plurality of sub-regions of the region (R);
receive a positioning response from a second communication device in the region, the positioning response indicating an acknowledgement of the positioning request; and
determine a position of the second communication device in the region based on the received positioning response from the second communication device.

2. The first communication device according to claim 1, further configured to:
receive a plurality of positioning responses from the plurality of positioning supporting devices, each positioning response indicating the acknowledgement of the positioning request; and
determine the position of the second communication device in the region further based on the plurality of positioning responses from the plurality of positioning supporting devices.

3. The first communication deviceaccording to claim 2, further configured to:
determine the position of the second communication device in the region further based on signal measurements of the plurality of position responses.

4. The first communication device according to claim 1, further configured to:
determine the position of the second communication device in the region further based on the distribution of the plurality of positioning supporting devices in the plurality of sub-regions of the region.

5. The first communication device according to claim 1, further configured to:
transmit a plurality of control signals to the plurality of positioning supporting devices, each control signal indicating a receive direction and/or a transmit direction for a positioning supporting device to cover a sub-region of the region.

6. The first communication device according to claim 5, wherein the receive direction and/or the transmit direction of the positioning supporting device comprises one or more of a transmit beam, a receive beam, a mechanical tilt, an antenna direction, a beam width, and a beam direction.

7. The first communication device according to claim 5, wherein the control signal further indicates a transmit power and/or a time/frequency resource for the positioning response.

8. The first communication device according to claim 1, wherein the positioning request indicates one or more of a reference signal to measure and report, a time/frequency reporting resource for the positioning response and a number of reporting bits for the positioning response.

9. The first communication device according to claim 8, wherein the positioning response further indicates a received signal strength of the reference signal.

10. The first communication device according to claim 1, wherein
the positioning request is a downlink control information (DCI), a sidelink control information (SCI) or a positioning protocol message; and/or
the positioning response is an uplink control information (UCI), an SCI or a positioning protocol message.

11. The first communication device according to claim 1, wherein the positioning supporting device is an intelligent reflecting surface, a transmission and reception point, a relay/repeater node, a network access node, or a client device.

12. A second communication device for a communication system, the second communication device being configured to:
receive a positioning request from a first communication device; and
transmit a positioning response to the first communication device in response to the positioning request, the positioning response indicating an acknowledgement of the positioning request.

13. The second communication device according to claim 12, wherein the acknowledgement of the positioning request comprises a bit, a signature or a positioning signal quality quantity.

14. The second communication device according to claim 12, further configured to:
receive a plurality of positioning requests from a plurality of positioning supporting devices distributed in a plurality of sub-regions of a region; and wherein the acknowledgement of the positioning request comprises an indication of received signal strengths of the plurality of received positioning requests.

15. The second communication device according to claim 14, further configured to:
estimate a position of the second communication device in the region based on the plurality of position requests received from the plurality of positioning supporting devices; and wherein the positioning response further indicates the estimate of the position of the second communication device in the region.

16. The second communication device according to claim 15, wherein the estimated position of the second communication device is within a sub-region of the region.

17. The second communication device according to claim 12, wherein the positioning request indicates one or more reference signals to measure and report, a time/frequency reporting resource for the positioning response and a number of reporting bits for the positioning response.

18. The second communication device according to claim 17, wherein the positioning response further indicates a received signal strength of the reference signal.

19. The second communication device according to claim 12, wherein
the positioning request is a downlink control information (DCI), a sidelink control information (SCI) or a positioning protocol message; and/or
the positioning response is an uplink control information (UCI), an SCI or a positioning protocol message.

20. A method for a second communication device, the method comprising:
receiving a positioning request from a first communication device; and
transmitting a positioning response to the first communication device in response to reception of the positioning request, the positioning response indicating an acknowledgement of the positioning request.
